(19) United States
(12) Patent Application Publication
(10) Pub. No.: US 2024/0383583 A1
(43) Pub. Date: Nov. 21, 2024

(54) 2-IN-1 KAYAK

(71) Applicant: Lifetime Products, Inc., Clearfield, UT (US)

(72) Inventors: Keely Bernal, Englewood, CO (US); Edward G. Van Nimwegen, North Ogden, UT (US)

(21) Appl. No.: 18/663,504

(22) Filed: May 14, 2024

Related U.S. Application Data
(60) Provisional application No. 63/503,421, filed on May 19, 2023.

(51) Int. Cl. B63B 73/50; B29C 49/20; B29C 49/42; B29L 31/30; B63B 5/24; B63B 34/21

(52) U.S. Cl. CPC B63B 73/50; B29C 49/20; B29C 49/4278; B63B 5/24; B63B 34/21; B29C 2049/2008; B29C 2793/0009; B29C 2793/009; B29L 2031/3067

(57) ABSTRACT

One example watercraft includes a blow-molded plastic hull in the form of a unified, single-piece, structure, and the structure of the blow-molded plastic hull defines first and second cutting paths. The watercraft also includes a sacrificial portion that is integral with the blow-molded plastic hull, and two different configurations of the sacrificial portion are respectively defined by the first and second cutting paths, and each of the two configurations of the sacrificial portion is removable from the blow-molded plastic hull so that a respective seating configuration is defined in the blow-molded plastic hull.

### TECHNOLOGICAL FIELD OF THE DISCLOSURE

One or more embodiments within the scope of this disclosure are directed to watercraft, examples of which include, but are not limited to, kayaks, and other human-powered watercraft. At least one example embodiment is directed to a pair of watercraft which, while they have different finished configurations, may be created using the same mold. In one embodiment, the two watercraft may differ from each other at least with regard to their respective seating configurations.

### BACKGROUND

Molds typically used in blow-molding processes may be expensive to design, create, and use. This is particularly the case where the blow-molded structure is relatively large, such as a kayak or other watercraft for example. Where, for example, two kayaks of different respective configurations are to be produced, the conventional approach is to create a different mold for each of the configurations. This approach has proven to be quite expensive and time consuming however.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1-8 disclose aspects of a watercraft which, after molding, is post-processed to define a first seat configuration, according to one embodiment. In particular:

FIG. 1 discloses a partial section view of a watercraft according to one embodiment that comprises a first seat configuration;

FIG. 2 discloses a partial top view of the example watercraft of FIG. 1;

FIG. 3 discloses a partial bottom view of the example watercraft of FIG. 1;

FIG. 4 discloses a section view of a first fore-and-aft location in the example watercraft of FIG. 1;

FIG. 5 discloses a section view of a second fore-and-aft location in the example watercraft of FIG. 1;

FIG. 6 discloses a top view and associated router path of the example watercraft of FIG. 1;

FIG. 7 discloses a side section view, partial section view, and top view, of the example watercraft of FIG. 1; and

FIG. 8 discloses a perspective section view, a top view, and associated router path, of the example watercraft of FIG. 1.

FIGS. 9-19 disclose aspects of a watercraft which, after molding, is post-processed to define a second seat configuration that is different from the first seat configuration, according to one embodiment. In particular:

FIG. 9 discloses a top view of a watercraft according to one embodiment that comprises a second seat configuration;

FIG. 10 discloses a top view and side section view of the example watercraft of FIG. 9;

FIG. 11 discloses a perspective section view, and a top view, of the example watercraft of FIG. 9;

FIG. 12A discloses a section view at a first fore-and-aft location in the example watercraft of FIG. 9;

FIG. 12B discloses a detail view from the section view of FIG. 12a;

FIG. 13 discloses a top view and associated router path of the example watercraft of FIG. 9;

FIG. 14 discloses a detail view and router path of the example watercraft of FIG. 9;

FIG. 15 discloses a bottom view of the example watercraft of FIG. 9;

FIG. 16 discloses a partial side section view of the example watercraft of FIG. 9;

FIG. 17 discloses a detail side section view, and associated router path, of the example watercraft of FIG. 9;

FIG. 18 discloses a detail side section view, and associated router path, of the example watercraft of FIG. 9; and

FIG. 19 discloses a partial top view of the example watercraft of FIG. 9.

FIG. 20 discloses aspects of an example mold insert such as may be used in the production of the example disclosed watercraft;

FIG. 21 discloses an example mold insert for creating a tack-off, according to one embodiment.

FIG. 22 discloses a detail view of the example mold insert of FIG. 21.

FIG. 23 discloses an example arrangement of mold inserts according to one embodiment.

FIG. 24 discloses aspects of a method according to one example embodiment.

### DETAILED DESCRIPTION OF SOME EXAMPLE EMBODIMENTS

Some example embodiments are directed to various watercraft such as, for example, a first watercraft and a second watercraft which, while they have different finished configurations, may be created using the same mold, such as a mold used for creating blow-molded structures. In one embodiment, the two watercraft, produced from the same mold, may differ from each other at least with regard to their respective seating configurations. In one embodiment, the watercraft may take the form of a sit-inside kayak, but that is not required. Other example embodiments are respectively directed to molds, mold inserts, and one or more methods for manufacturing the example first watercraft and second watercraft. These embodiments are presented by way of example and are not intended to limit the scope of this disclosure, or the claims, in any way.

In one example embodiment, a watercraft may be created in a mold, using a blow-molding process. The watercraft may then be removed from the mold and further processed to create one or more features in the watercraft. For example, the watercraft may be routered, using a router tool that may be robotically controlled, along a first router path, to at least partly define a first seat configuration. Alternatively, after the watercraft is removed from the mold, the watercraft may be routered, along a second router path, to at least partly define a second seat configuration that is different from the first seat configuration.

In an embodiment, the first router path and the second router path may have one or more portions in common with each other.

In an embodiment, an insert or other device may be employed in the mold during the blow-molding process to create, or enable the creation of, a feature in one, or the other, of the first watercraft and the second watercraft. The presence, or lack, of the feature in one of the watercraft may correspond to the seat configuration of that watercraft.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of this disclosure or the claims in any way. It should further be noted that nothing herein should be construed as constituting an essential or indispensable element of any claim or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a common mold, and an identical, or nearly identical, base watercraft configuration, may be used to create each of multiple different watercraft configurations. In an embodiment, the same mold, and the identical, or nearly identical, base watercraft configuration, may be used to create each of multiple different watercraft having different respective seat configurations. Various other advantages of some example embodiments will be apparent from this disclosure.

### A. General Aspects of Some Embodiments

In general, the watercraft and components disclosed herein may be constructed with a variety of elements and materials including, but not limited to, plastic (including blow molded plastic structures and elements) such as high density polyethylene (HDPE), including polycarbonates, composites, metals, and combinations of any of the foregoing. In an embodiment, a watercraft may take the form of a sit-inside kayak configured so that at least part of the body of a user is positioned within the hull of the kayak during normal use.

Any embodiment of a kayak, or other watercraft, that includes a hull having a unified, single-piece construction, which is comprised of blow-molded, or otherwise formed, plastic may have an interior that is partly, or completely, hollow. Such embodiments may also include, disposed in the interior, one or more depressions, sometimes referred to as “tack-offs.” In such embodiments, these tack-offs may be integrally formed as part of a unitary, one-piece structure during the blow-molding process. The depressions may extend from a first surface, such as a first interior surface of the hull, towards a second surface, such as a second interior surface of the hull. The ends of one or more depressions may contact or engage the second surface, or the ends of one or more of the depressions may be spaced apart from the second surface by a distance.

In some instances, one or more depressions on a first interior surface may be substantially aligned with corresponding depressions on a second interior surface, and one or more depressions on the first interior surface may contact one or more corresponding depressions on the second interior surface or, alternatively, one or more depressions on the first interior surface may be spaced apart from corresponding depressions on the second interior surface. In still other instances, depressions that contact each other and depressions that are spaced apart from each other may both be present in a kayak or other watercraft. The depressions may be sized and configured to strengthen and/or reinforce the blow-molded plastic hull of the kayak or other watercraft. Finally, the depression, or depressions, can be any shape or size, and depressions of different respective shapes and/or sizes can be combined in a single watercraft.

As well, example embodiments may include one or more parting lines which may comprise vestigial portions of plastic present on a molded part after molding has been completed. In general, the vestigial portions of plastic comprise plastic that has escaped into a joint between portions of a mold. Additionally, or alternatively, a finished molded part may include visible indicia, such as parting lines for example, where vestigial portions of plastic have been removed from a molded part, such as by grinding for example. Thus, in an embodiment, one, some, or all, vestigial portion(s) is/are omitted from the finished product.

The vestigial portions of plastic, and the corresponding parting lines, may be formed, and/or located at, a junction of the halves of a mold, or mold portion, that is used to make the molded part. That is, the vestigial portions of plastic may be formed when two portions of a mold come together during a molding process.

Example embodiments may include elements such as parting lines. In some particular embodiments, a parting line may extend along part, or all, of a length of a molded element such as a hull of a watercraft. Embodiments may include one or more parting lines formed by compression molding, and/or one or more parting lines formed by blow molding.

In an embodiment, two watercraft may be identical, or nearly identical, to each other except for their respective seat configurations, and except that one of the watercraft may comprise a feature, such as a pair of tack-offs for example, in a particular location, that the other watercraft does not have. That is, in an embodiment, either of the first watercraft or second watercraft may be created using a mold that includes one or more mold inserts, or simply ‘inserts,’ which, during a blow-molding process, create, or enable the creation of, one or more features, such as the aforementioned tack-offs, of the first watercraft or second watercraft.

Regardless of the presence, or lack, of the tack-offs, and notwithstanding differences in the respective seat configurations, the same mold may be used to create both the first watercraft and the second watercraft. As such, the two watercraft may be identical to each other except with respect to their respective seat configurations. Mold inserts may be used in producing both the first watercraft and the second watercraft, although the mold inserts used for one of the two watercraft may be a different length, size, and/or shape, than the mold inserts used for the other of the two watercraft. In an embodiment, a structure created and/or enabled by the use of a mold insert may serve as a support for a seat to be installed in the watercraft.

In an embodiment, the different seat configurations may be defined using various production processes. For example, by routering different respective portions of two watercraft after the watercraft have been removed from a mold, two different seat configurations may be defined. In an embodiment, the routering may be performed, and/or controlled by, a robot. The different routering processes may comprise removal of different respective portions of the two watercraft although, in one embodiment, the respective router paths associated with the different routering processes may have a portion in common with each other.

Example embodiments of a first watercraft and second watercraft, and associated production processes and equipment, are discussed in turn below. These examples are provided by way of illustration and are not intended to limit the scope of disclosure or the claims in any way.

### B. Aspects of a First Example Watercraft

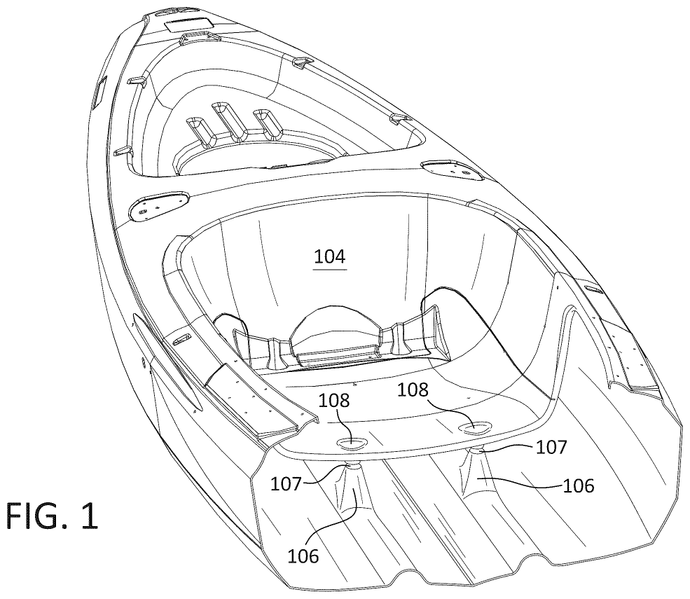

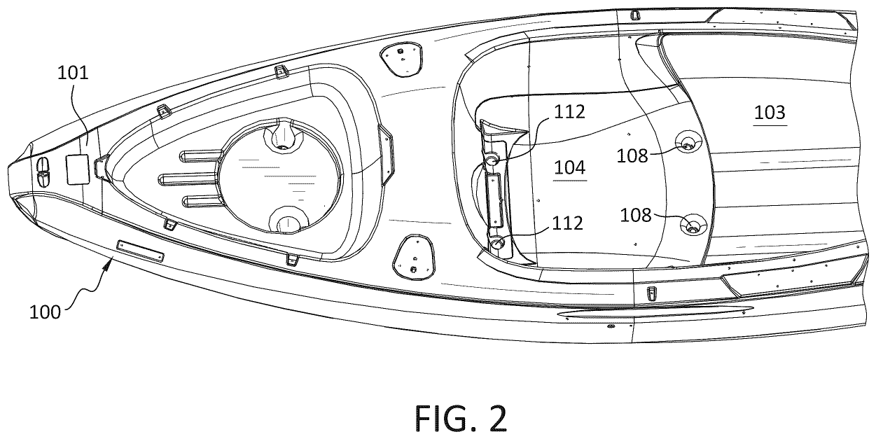

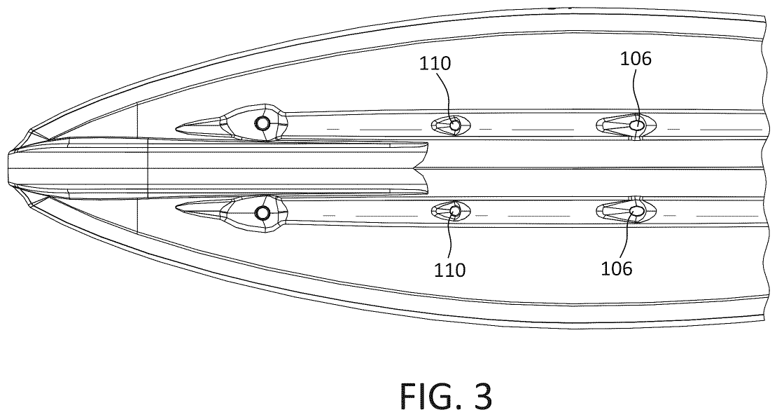

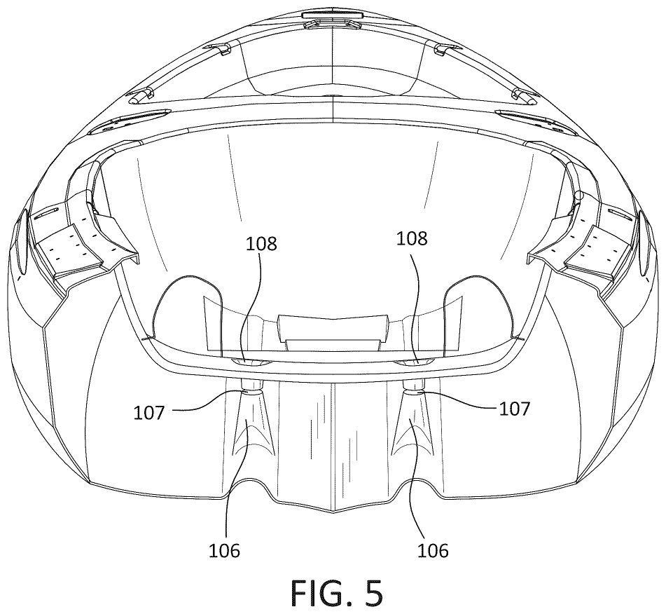

With attention first to FIGS. 1-8, a watercraft 100, such as a sit-inside kayak for example, is disclosed that includes a hull 101. The hull 101 may be an integral plastic blow-molded structure of a unified, single-piece construction. In other embodiments, the hull 101 may be constructed using processes such as injection molding, stretch blow molding, rotomolding, or twin sheet molding.

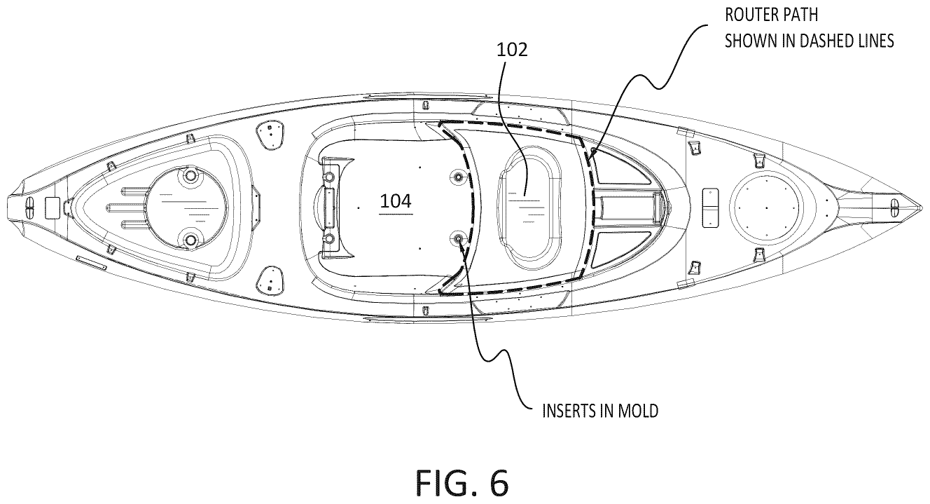

As best shown in FIGS. 6-8, the watercraft 100 may, upon removal from a mold after completion of a blow-molding process, but before any routering has been performed, include a sacrificial portion 102. This sacrificial portion 102 may be removed by a routering process in which a router bit penetrates the plastic of the hull and is moved along the router path indicated in the Figures. Note that, in an embodiment, the sacrificial portion 102 may comprise a part of a larger sacrificial portion 202 discussed below. Thus, and as noted elsewhere herein, different router paths may be used to define the configuration of a particular watercraft. That is, removing only the sacrificial portion 102 defines one configuration of a watercraft, while removal of the larger sacrificial portion 202 defines another, different, configuration of a watercraft.

It is noted that a routering process, and associated router bit, are provided only by way of example. More generally, an embodiment may employ any suitable cutting tool, examples of which include, but are not limited to, knives, saws, and grinders. These other cutting tools may, or may not, be robotically controlled. For example, where a rotomolding process is used to create a watercraft, according to one embodiment, the plastic hull of the watercraft may be relatively warm and pliable upon removal of the watercraft from the rotomold. In this example implementation, a knife may be used to cut away part, or all, of a sacrificial portion, examples of which are disclosed herein. Use of a knife, such as just described, may or may not comprise a manual process performed by a human. Thus, while a routering path may be referred to herein as a path taken by a router bit, an embodiment may comprise and/or use, more generally, a cutting path that may be taken or followed by a cutting tool.

After completion of the routering process, and removal of the sacrificial portion 102, the watercraft 100 may appear as shown in FIGS. 1, 2, and 4-6, for example. As shown, an open cockpit 103 may be defined that is sized and configured to receive a seat, as discussed in more detail below. As further indicated in those Figures, a seat portion 104 may remain after the sacrificial portion 102 has been removed.

By way of comparison, in another embodiment, the seat portion 104 may comprise a rear part of the sacrificial portion 202. As such, the seat portion 104 may be removed, as part of the sacrificial portion 202, in one embodiment, but retained in another embodiment. Notably, the same hull may be used for either configuration.

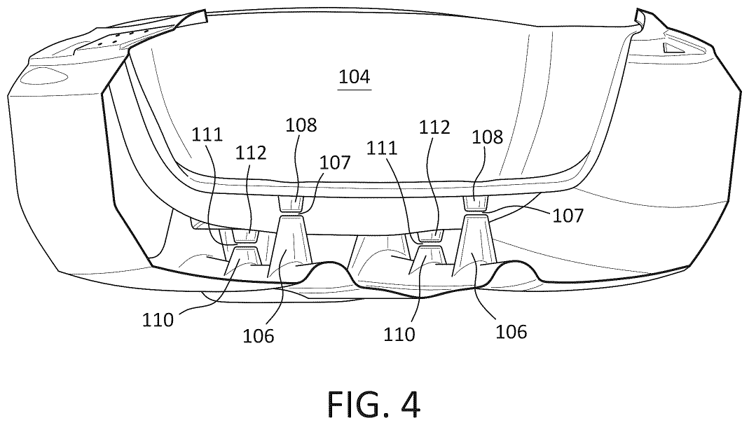

As best shown in FIG. 4, removal of the sacrificial portion 102 may expose, and leave in place, two projections 106, formed during the blow molding, that may tack-off, that is form a tack-off 107, by contacting the bottoms of corresponding recesses 108 formed in the seat portion 104 during the blow-molding process. The projections 106 may be hollow, and may be integrally formed with the hull 101. The tack-offs 107 may be formed in the mold with the use of inserts, and the tack-offs 107 may lend strength and stiffness to the front part of the seat portion 104. By way of contrast, the projections 204, discussed below, may be created using mold inserts that are shorter than the mold inserts used to create the tack-offs 107. As consequence of their shorter length, these latter mold inserts may not create tack-offs during a blow-molding process.

Still other projections 110 may be formed during the molding process near the back of the seat portion 104. The projections 110 may form tack-offs 111 by contacting the bottoms of corresponding recesses 112. Similar to the tack-offs 107, the tack-offs 111 may lend strength and stiffness to the seat portion 104, particularly at the back of the seat portion 104.

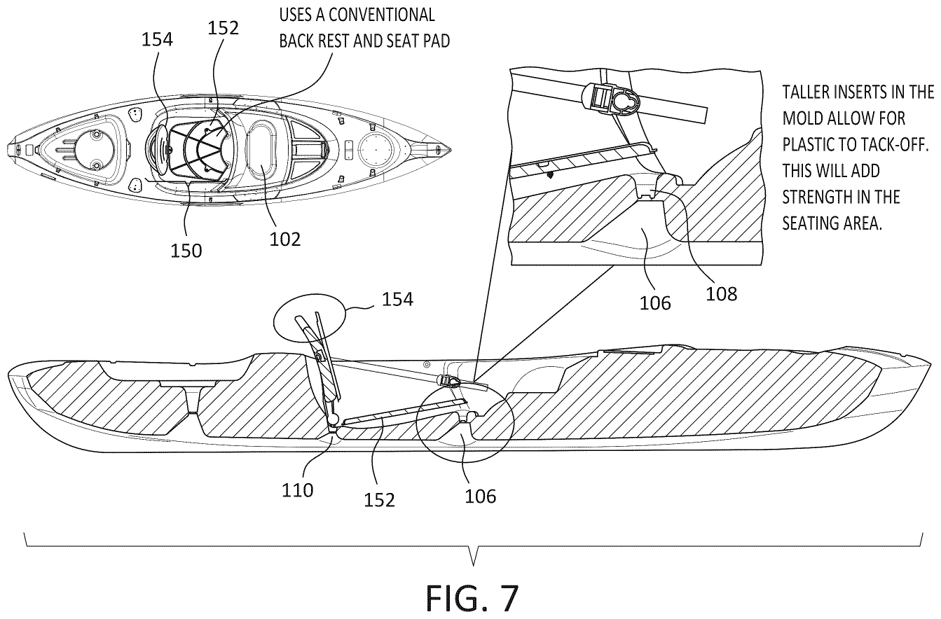

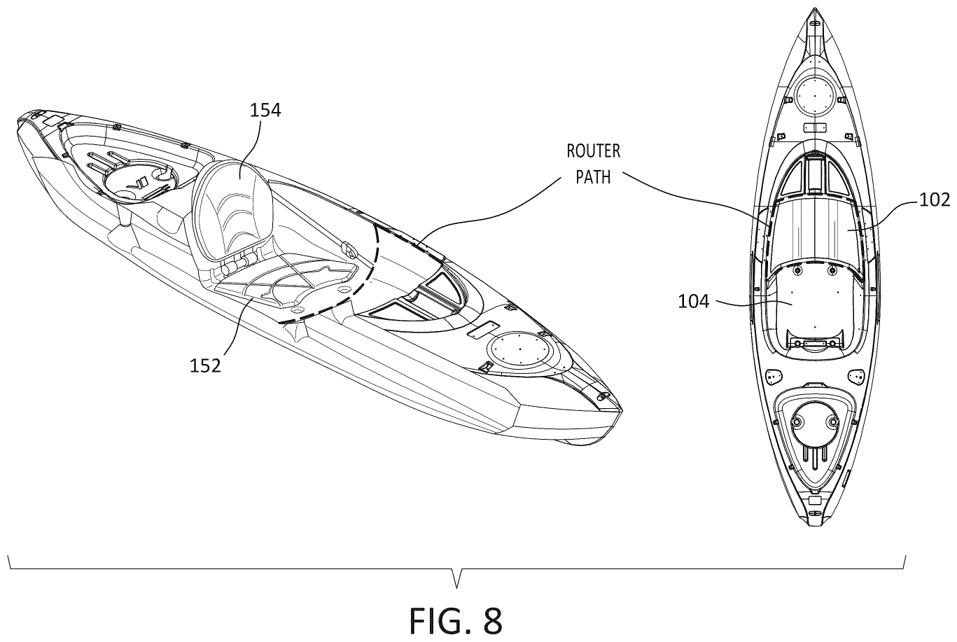

With continued reference to FIGS. 7 and 8 in particular, removal of the sacrificial portion 102 may enable installation of a seat 150, which may be removably installed in the watercraft 100. In an embodiment, the seat 150 may comprise a seat pad 152, attached to the seat portion 104, and a back rest 154. As noted, the tack-offs 107 and 111 may provide support for the seat 150.

### C. Aspects of a Second Example Watercraft

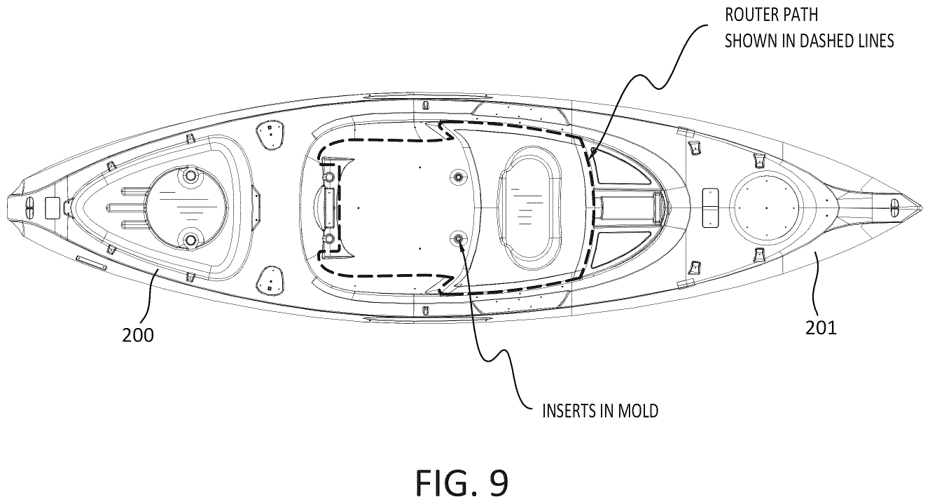

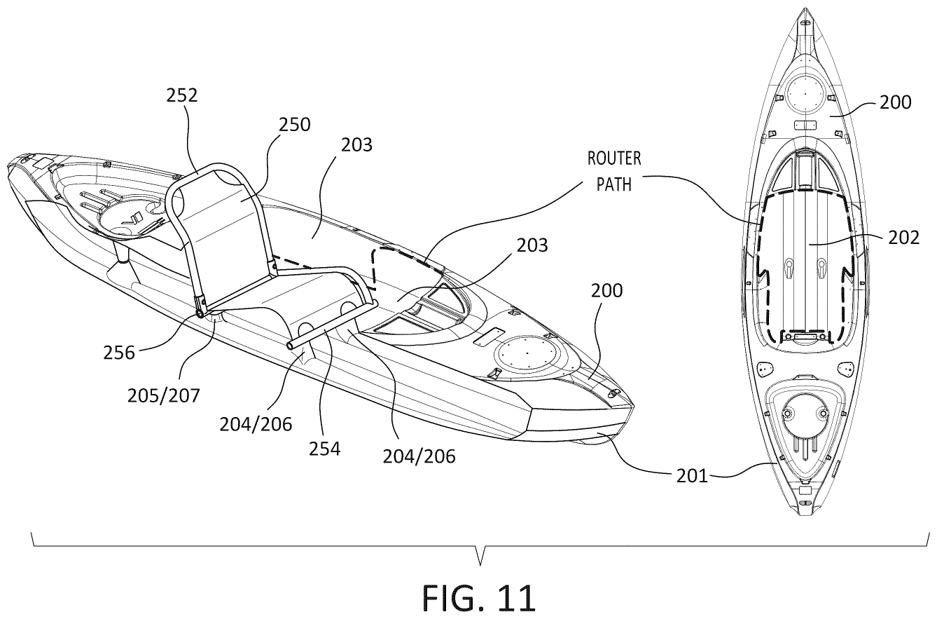

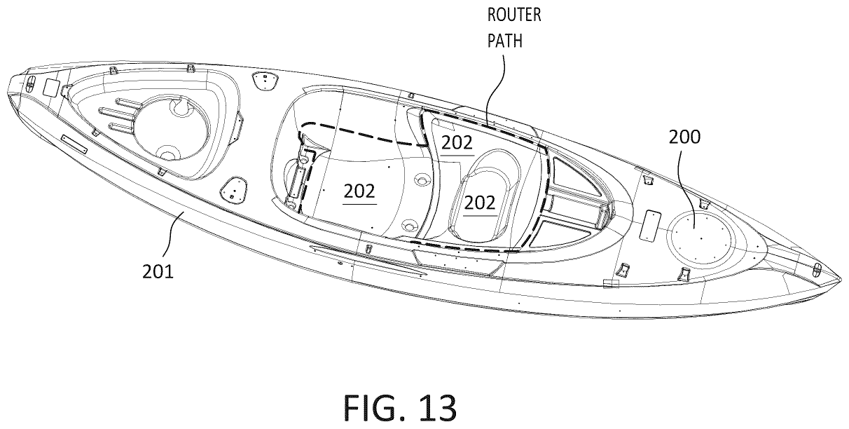

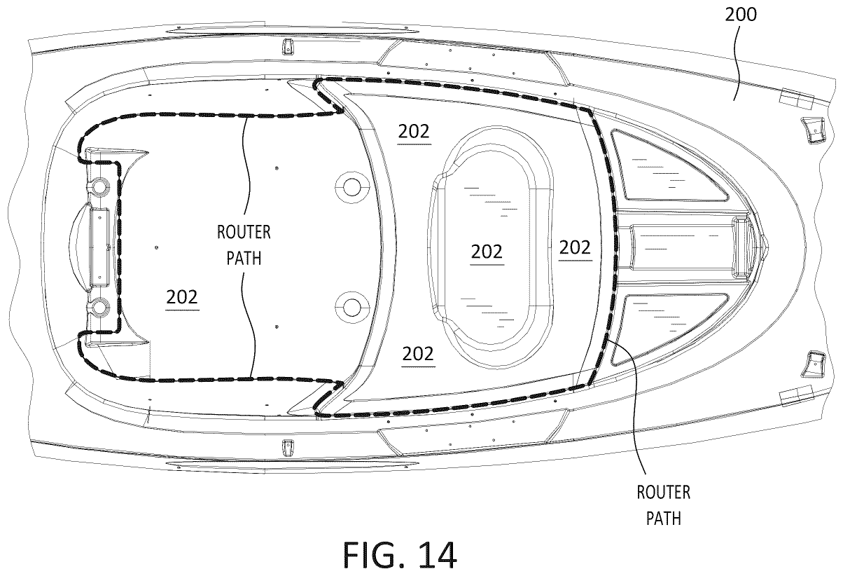

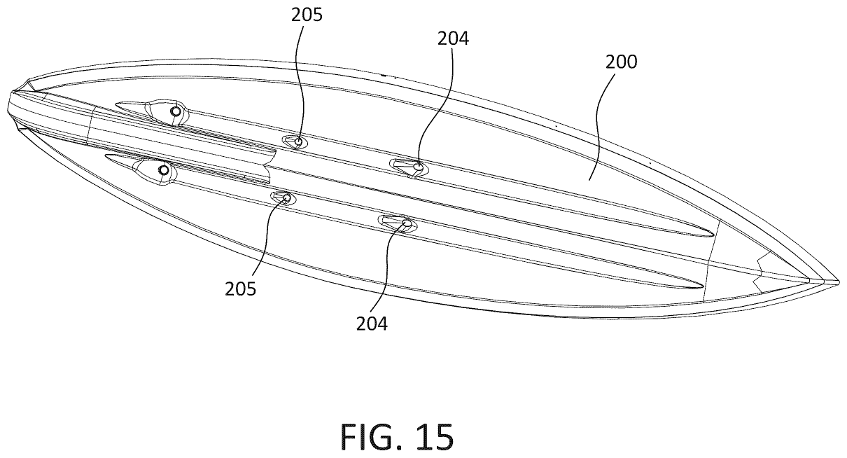

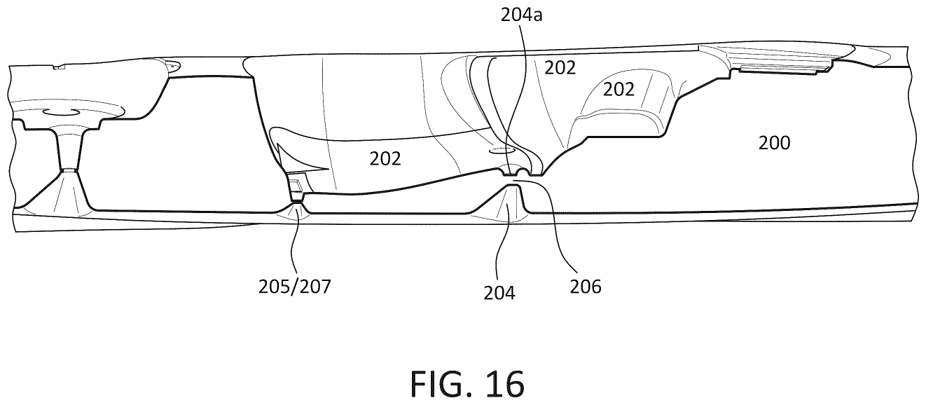

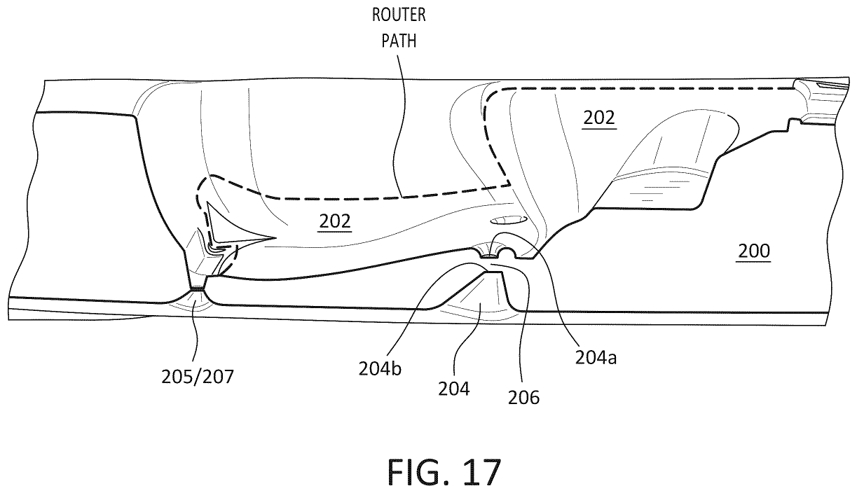

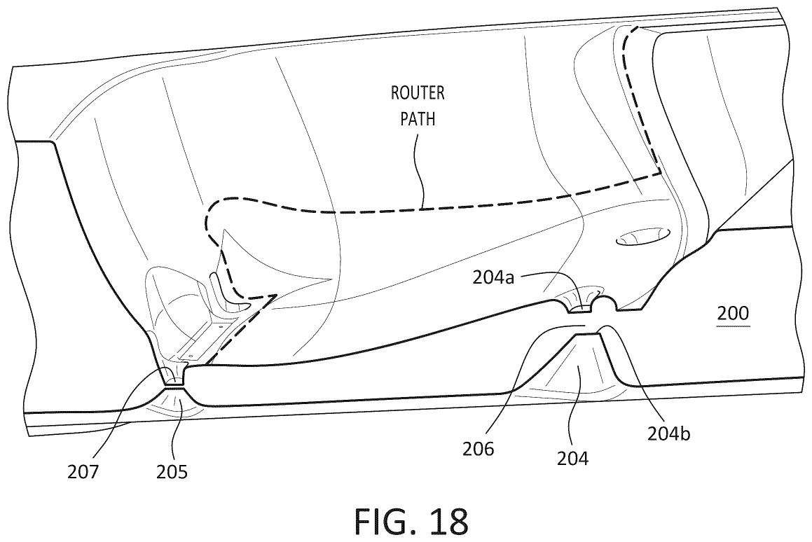

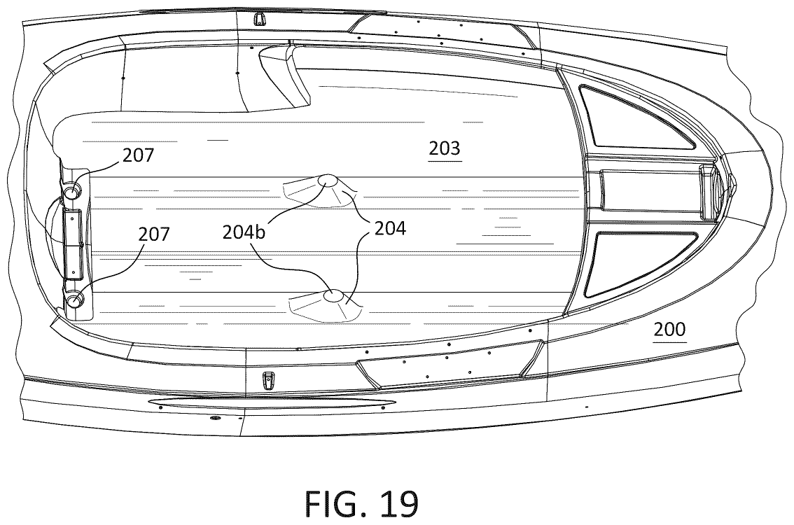

With attention now to FIGS. 9-19, a second example watercraft 200 is disclosed that may comprise a hull 201 that may be similar, or identical, to the hull 101. As shown in one or more of those Figures, particularly FIGS. 13 and 14, the watercraft 200 may, upon removal from a mold, but before any routering has been performed, include a sacrificial portion 202. This sacrificial portion 202 may be removed by a routering process in which a router bit penetrates the plastic of the hull and is moved along the router path indicated in FIGS. 9 and 11. After completion of the routering process, and removal of the sacrificial portion 202, the watercraft 200 may appear as shown in FIGS. 11 and 19. As shown, an open cockpit 203 may be defined that is sized and configured to receive a seat, as discussed in more detail below.

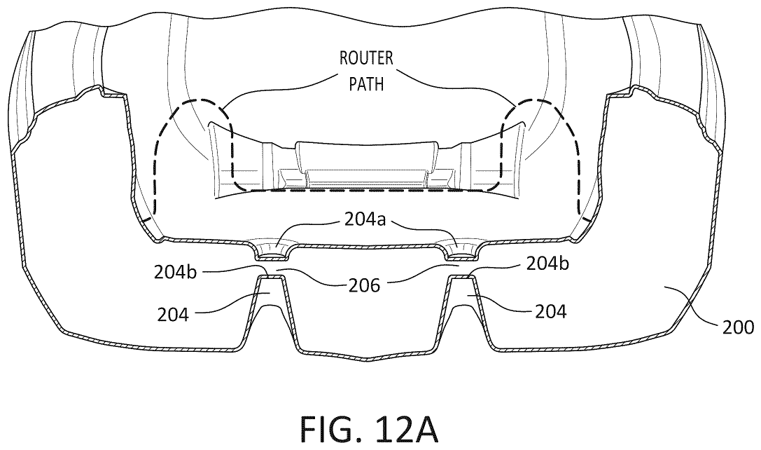

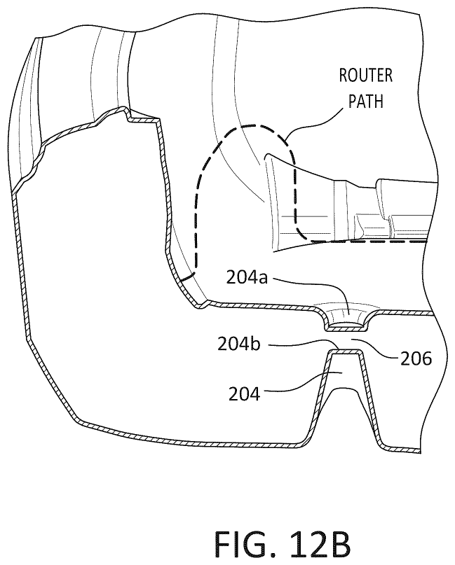

With reference now to FIGS. 12a and 12b, removal of the sacrificial portion 202 may expose, and leave behind, two projections 204 that may be integral elements of the watercraft 200. As best shown in FIGS. 12a, 12b, 17 and 18, one or more air gaps 206 may be defined that space the projections 204 apart from corresponding projections 204a. In this second example embodiment, and in contrast with the first example embodiment discussed above with respect to FIGS. 1-8, relatively shorter inserts, that is, shorter relative to the length of the inserts used in connection with production of the first example embodiment, may be used in the mold when manufacturing the second example embodiment so as to facilitate the formation of the air gaps 206, and the use of the shorter inserts may also enable maintenance of the wall thickness (shown outline in FIG. 12b) of the projection 204 and 204a.

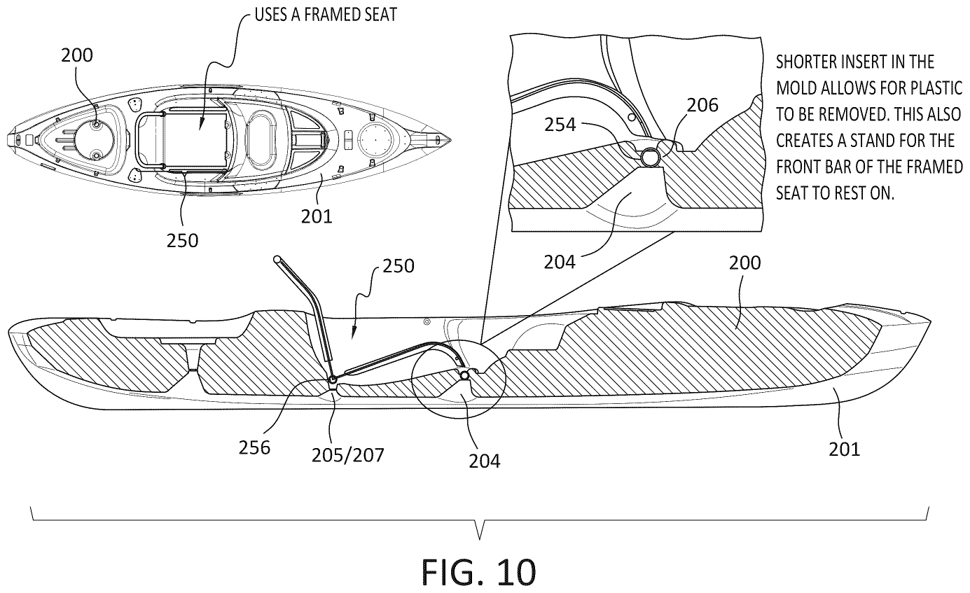

With reference to FIGS. 10 and 11 in particular, removal of the sacrificial portion 202 may enable installation of a seat 250, which may be removably installed in the watercraft 200. In an embodiment, the seat 250 may comprise a framed seat that includes a frame 252, which may be made of aluminum, aluminum alloy, plastic, fiberglass, composite, or other suitable material(s). The frame 252 may include a front bar 254 configured and arranged so that when the seat 250 is fully installed in the watercraft 200, the front bar 254 rests on, and is supported by, the respective tops 204b of the projections 204. A back bar 256 may also be provided as an element of the seat 250. The projections 205, which may or may not be solid, and corresponding tack-offs 207, may support the back bar 256 of the seat 250.

### D. Aspects of an Example Mold Insert

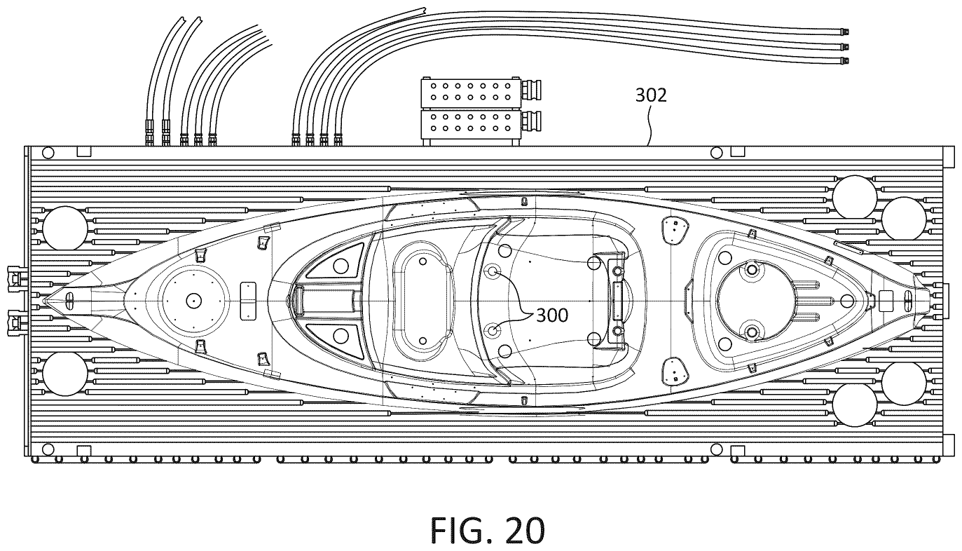

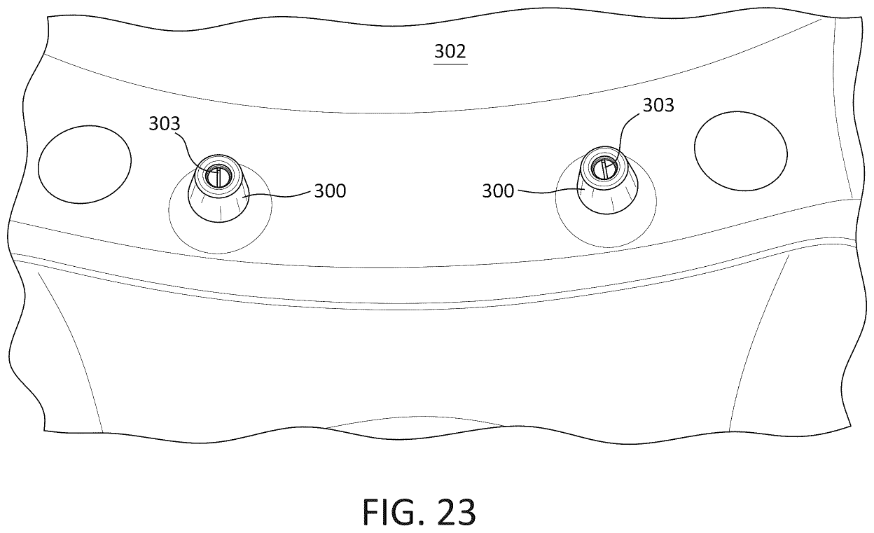

With reference now to FIGS. 20-23, details are provided concerning an example mold insert 300 that may be used in creating tack-offs in a watercraft, such as the tack-offs 107 shown in FIG. 4, for example. In general, one or more of the mold inserts 300 may be placed in a mold prior to a blow-molding process so that, upon completion of the blow-molding process, respective tack-offs have been formed in the watercraft by each of the mold inserts 300. The mold insert 300 may be removable from the mold so that another watercraft may be created using the same mold, but without tack-offs formed by a mold insert. As noted herein, a first example embodiment may comprise one or more tack-offs formed by respective mold inserts, while a second example embodiment may also use mold inserts but those inserts may be sufficiently short that they do not create tack-offs.

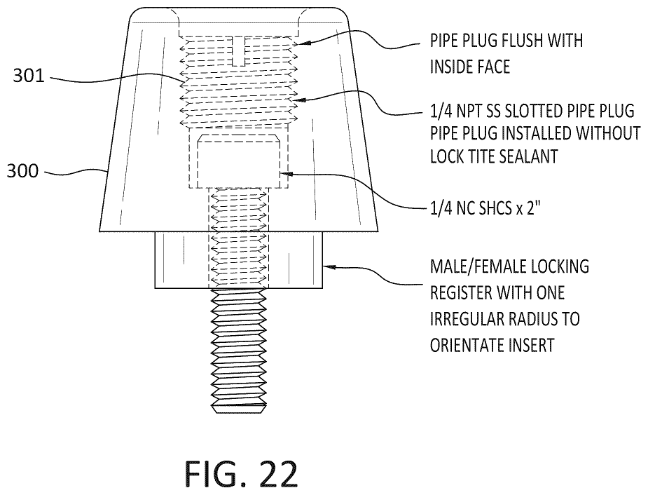

As shown in FIGS. 20-23, a respective mold insert 300 may be installed, possibly removably, in a mold 302 to create each tack-off that is to be formed in the watercraft. In one embodiment, the shape of the example mold insert 300 generally corresponds to the shape of the recess that is to be formed by the mold insert 300 during the molding process. Note, for example, the correspondence between the shape of the mold insert 300 in FIG. 22, and the shape of the recesses 108 in FIGS. 1, 2, 4 and 5. Similarly, a length, or height, of a mold insert may correspond to the depth of a recess created with that mold insert.

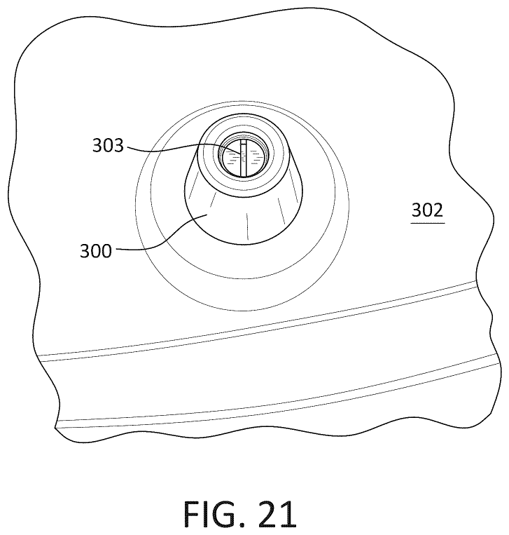

As shown in the example of FIGS. 21-23, the mold insert 300 may comprise a slotted stainless steel plug 301 tapped to depth to be flush with an interchangeable scupper face. The slot 302 may be oriented inline with the parison that is used to create the blow-molded object. The slot 302, only, may be epoxied flush, filling any exposed threads, as shown in FIG. 22. To remove the epoxy, a user can strike the mold insert 300 with a flat edge, and then start to unscrew the plug to break the remaining epoxy in the threads.

### E. Example Method According to an Embodiment

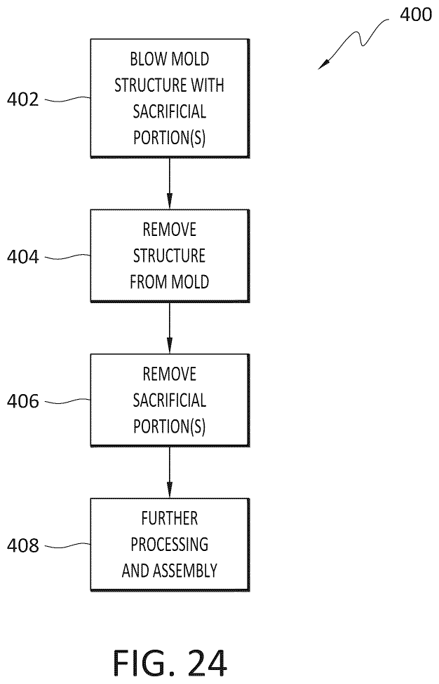

With reference now to FIG. 24, an example method 400 according to one embodiment is disclosed. The example method 400 may begin with the blow-molding 402 of a structure that includes one or more sacrificial portions. That is, the sacrificial portions are created by the blow-molding process, and the sacrificial portions are integrally formed with the rest of the blow-molded structure, or simply ‘structure.’ In an embodiment, the structure comprises a watercraft, one example of which is a kayak. In an embodiment, the kayak may comprise a sit-inside configuration, but may comprise an alternative configuration in another embodiment.

After the blow-molding process 402 has been completed, the structure may be removed 404 from the mold. After removal 404, the structure may be allowed to cool to room temperature, or a temperature above room temperature.

At some point after the structure has been removed 404 from the mold, one or more of the sacrificial portions 406 may be removed from the structure. In one embodiment, a first sacrificial portion may completely encompass a second sacrificial portion. Thus, a first configuration of the structure may be defined by removing only the second sacrificial portion. Alternatively, a second configuration of the structure, different from the first configuration of the structure, may be defined by removing the first sacrificial portion that also encompasses the entire, or at least more than half of, the second sacrificial portion. In one embodiment, the first sacrificial portion and the second sacrificial portion may have different respective sizes, and different respective geometries.

In one embodiment, structures, such as kayaks or other watercraft for example, from which the first sacrificial portion and the second sacrificial portion, respectively, have been removed, may be physically identical to each other except with regard to those respective portions of the structures where either the first sacrificial portion, or the second sacrificial portion, has been removed. In one embodiment, the structures may comprise respective watercraft, each of which has a different respective seating configuration as a result of removal of one or the other of the first sacrificial portion or the second sacrificial portion.

As noted earlier herein, removal 406 of the sacrificial portions may be performed with a cutting tool, such as a router for example. The cutting tool may be robotically controlled. Various other cutting tools, and methods, may be used to remove 406 the sacrificial portions however.

After removal 406 of the sacrificial portions, which, upon removal, no longer form a part of the blow-molded structure, further processing and assembly 408 may be performed on the structure to bring the structure to its final, finished, form. The sacrificial portion(s), having been removed 406, form no part of the final, finished, structure.

In an embodiment, the processing and assembly 408 may comprise, for example, installation of one or more seats, or portions of seats, in the area of the blow-molded structure from which the sacrificial portion was removed 406. In one embodiment, the processing and assembly 408 may comprise removing, from the structure, any integral vestigial portions formed on a portion of the structure where the mold halves came together when the structure was being blow molded 402. Removal of the vestigial portions as part of the processing and assembly 408 may reveal one or more part lines that are integral with the structure. In one embodiment, removal of vestigial portions may be performed before removal 406 of the sacrificial portion(s).

### F. Aspects of an Example Alternative Embodiment

In one alternative embodiment, the hull of a watercraft may be molded in a configuration in which projections, such as the projections 204 and 204a (see FIG. 12a) for example, do not touch each other, and thus define a gap, such as the gap 206. In this example alternative embodiment, a spacer may be added to fill the gap. Placing a spacer in this way adds structure that may provide support in an area of a seat portion, such as the seat portion 104 for example. As well, by filling the gap, the spacer eliminates the possibility that, under a dynamic load, the protrusions that define the gap will come together periodically and make a tapping sound. Finally, by filling the gap, the spacer may eliminate a pinch point for the finger or hand of a user.

The described embodiments are to be considered in all respects only as illustrative and not restrictive. All changes which come within the meaning and range of equivalency of the claims are to be embraced within their scope.

What is claimed is:

1. A watercraft, comprising:
a blow-molded plastic hull in the form of a unified, single-piece, structure, and the structure of the blow-molded plastic hull defines first and second cutting paths; and
a sacrificial portion that is integral with the blow-molded plastic hull, and two different configurations of the sacrificial portion are respectively defined by the first and second cutting paths, and each of the two configurations of the sacrificial portion is removable from the blow-molded plastic hull so that a respective seating configuration is defined in the blow-molded plastic hull.

2. The watercraft as recited in claim 1, wherein the watercraft comprises a kayak.

3. The watercraft as recited in claim 1, wherein the first cutting path is different from the second cutting path.

4. The watercraft as recited in claim 1, wherein part of the first cutting path is included in the second cutting path.

5. The watercraft as recited in claim 1, wherein the second cutting path is longer than the first cutting path.

6. The watercraft as recited in claim 1, wherein the two configurations of the sacrificial portion differ from each other in their respective sizes, and respective shapes.

7. The watercraft as recited in claim 1, wherein the respective seating configurations are different from each other.

8. The watercraft as recited in claim 1, wherein one of the sacrificial portions covers one or more protrusions that are integral with the hull and which, when the sacrificial portion is removed, are positioned to support a portion of a seat.

9. The watercraft as recited in claim 1, wherein the watercraft comprises one or more tack-offs positioned below the sacrificial portion.

10. The watercraft as recited in claim 1, wherein the sacrificial portion includes a structure that defines part of a tack-off, and the tack-off is positioned below the sacrificial portion.

11. A method, comprising:
performing a blow-molding process to create a watercraft that includes an integral sacrificial portion;
removing the watercraft from a mold after the blow-molding process is complete; and
removing, using a cutting tool, part, or all, of the sacrificial portion of the watercraft so as to define either a first seating configuration or a second seating configuration in the watercraft.

12. The method as recited in claim 11, wherein the watercraft comprises a sit-inside kayak.

13. The method as recited in claim 11, wherein the first configuration comprises a seat portion that is integral with the watercraft.

14. The method as recited in claim 11, wherein the removing comprises robotically routering the watercraft to remove the sacrificial portion.

15. The method as recited in claim 11, wherein a size of the sacrificial portion removed to define the first seating configuration is different from a size of the sacrificial portion removed to define the second seating configuration.

16. The method as recited in claim 11, wherein a first path followed by the cutting tool to define the first seating configuration is different from a second path followed by the cutting tool to define the second seating configuration.

17. The method as recited in claim 16, wherein the first path and the second path include a portion in common with each other.

18. The method as recited in claim 11, wherein the performing of the blow molding process comprises creating one or more tack-offs configured and arranged to support a seat portion of the watercraft.

19. The method as recited in claim 18, wherein the tack-offs are created using inserts that are located in a mold that is used in the blow molding process to create the watercraft.

20. The method as recited in claim 11, wherein the first configuration is configured to accept a seat pad and a seat back, and the second configuration defines a second seat configuration that is configured to accept a frame seat.
